(19) United States
(12) Patent Application Publication
(10) Pub. No.: US 2010/0194652 A1
(43) Pub. Date: Aug. 5, 2010

(54) ANTENNA STRUCTURE WITH AN EFFECT OF SERIALLY CONNECTING CAPACITANCES

(76) Inventor: Chi-Ming CHIANG, Pa-Te City (TW)

Correspondence Address: Guice Patents PLLC, 12647 Galveston Court #302, Manassas, VA, 20112, US

(21) Appl. No.: 12/364,681

(22) Filed: Feb. 3, 2009

(51) Int. Cl. H01Q 9/00; H01Q 1/50; H01Q 1/38

(52) U.S. Cl. 343/745; 343/861; 343/700 MS

(57) ABSTRACT

In an antenna structure having an effect of serially connecting capacitances, mainly a metallic planar antenna is provided thereon at least with a first metallic plane board, and a second metallic plane board being close to but not connected to the first metallic plane board to form the effect of serially connecting capacitances. And more, the antenna structure further has an extension arm extended from the antenna or the second metallic plane board made from a microstrip, and can be optionally grounded or not grounded, for the purpose of adjusting the impedance value of the antenna structure.

### BACKGROUND OF THE INVENTION

1. Field of the Invention

The present invention is related to a brand new antenna structure, and especially to an antenna structure having an effect of serially connecting capacitances.

2. Description of the Prior Art

By fast development of communication techniques, mobile equipment are required to be compacted in volume, multi-frequency metallic planar antennas have become mainstream elements of mobile phones or notebooks for receiving or emitting radio signals.

Traditionally, metallic planar antennas are connected with circuit boards in mobile equipment via SMT elements. By virtue that normal SMT elements are designed to be impedances of fixed standard values, antennas still need matched electric circuits to adjust the values of capacitances and inductances, this may induce inconvenience of designing, and limit the frequency widths and effects of the antennas. Therefore, improvement is expected.

In a U.S. Pat. No. 6,542,123 titled “HIDDEN WIDEBAND ANTENNA” of the applicant, an inwardly recessed section, a back folded section and a protruding sheet extend out of an antenna for adjusting matching frequency. By the fact that the measures used in the patent makes elongation of the antenna to be unable to appropriately adjust values of capacitances and inductances, the designing of antennas still is limited.

### SUMMARY OF THE INVENTION

Therefore, the present invention provides an antenna structure having an effect of serially connecting capacitances, wherein, mainly a metallic planar antenna is provided thereon at least with a first metallic plane board, and a second metallic plane board being close to but not connected to the first metallic plane board to form the effect of serially connecting capacitances.

And more, the present invention further has an extension arm extended from the antenna or the second metallic plane board made from a microstrip, and can be optionally grounded or not grounded, for the purpose of adjusting the impedance value of the antenna structure.

The matching method for the antenna structure of the present invention is completed according to the principle of microstrip, such an antenna structure can make impedance matching to increase frequency width and efficiency, and allow adjustment of the values of electric inductance and capacitance at will; contrarily, a conventional antenna structure connected with SMT elements can only select impedance of a standard value. Therefore, the present invention has significant superiority in designing antennas.

The present invention will be apparent in its structure and effect after reading the detailed description of the preferred embodiment thereof in reference to the accompanying drawings.

### BRIEF DESCRIPTION OF THE DRAWINGS

FIG. 1 is a perspective view showing the appearance of a first embodiment of the present invention;

FIG. 2 is a chart showing standing wave voltage ratios of the first embodiment of FIG. 1;

FIG. 3 is a perspective view showing the appearance of a second embodiment of the present invention;

FIG. 4 is a chart showing standing wave voltage ratios of the second embodiment of FIG. 2.

### DETAILED DESCRIPTION OF THE PREFERRED EMBODIMENT

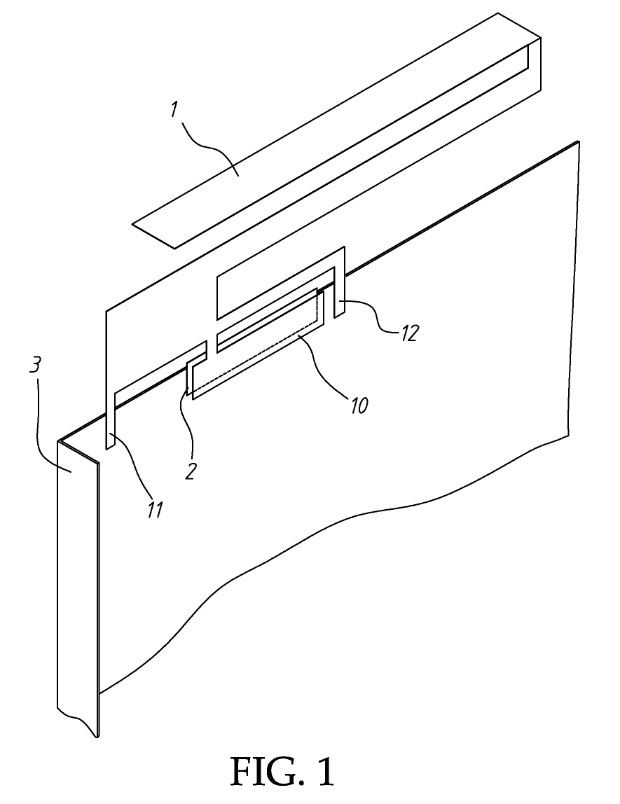

Referring to FIG. 1 showing the first embodiment of antenna structure of the present invention, the antenna structure comprises an antenna 1 and a second metallic plane board 2 both provided on a circuit board 3 having a grounding surface.

The antenna 1 is a metallic planar antenna used to receive and emit radio signals, and has thereon a first metallic plane board 10. And the second metallic plane board 2 close to but not connected to the first metallic plane board 10 to form an effect of serially connecting capacitances for the antenna structure.

And more, the antenna 1 further has an extension arm 11 extended therefrom for grounding, thereby the antenna structure forms an effect of parallelly connecting inductances, the antenna 1 forms a second extension arm 12 along the periphery of the first metallic plane board 10, the second extension arm 12 is not grounded to make an effect of parallelly connecting capacitances. The first metallic plane board 10 and the second extension arm 12 can both be made from microstrips.

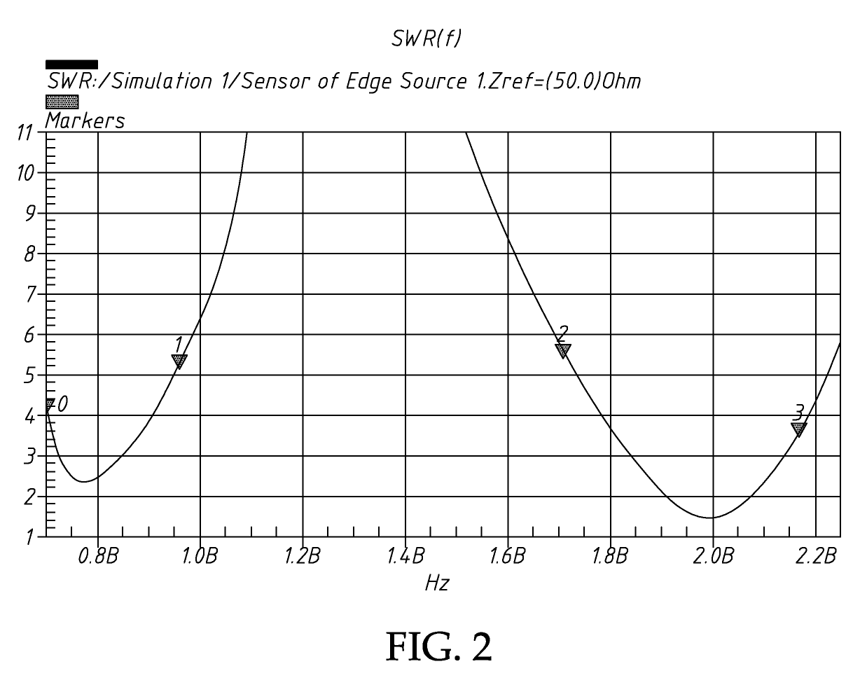

FIG. 2 shows a standing wave voltage ratio chart of the embodiment of FIG. 1, and shows that the antenna structure is a good multi-frequency antenna structure.

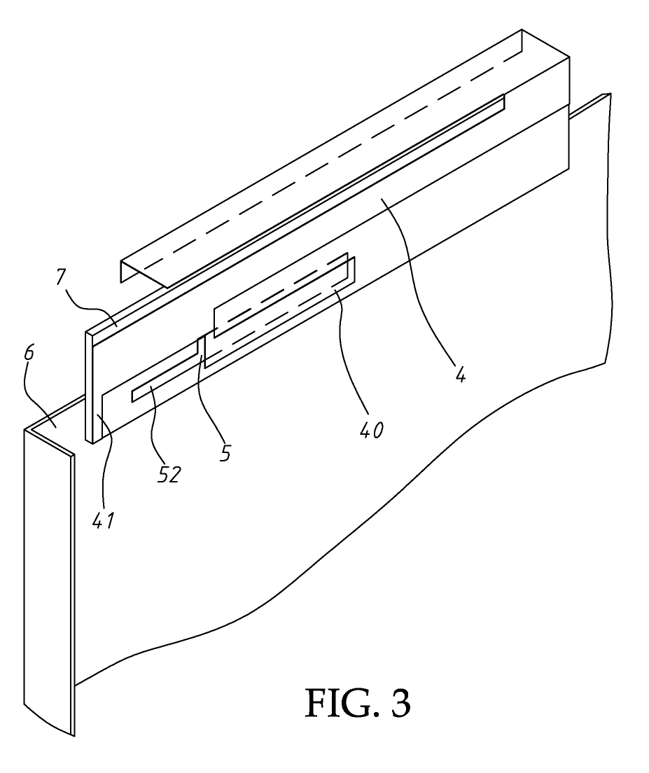

Referring to FIG. 3 which shows a second embodiment of the present invention, similarly, the embodiment comprises an antenna 4 and a second metallic plane board 5 both provided on a circuit board 6 having a grounding surface.

The antenna 4 is a metallic planar antenna used to receive and emit radio signals, and has thereon a first metallic plane board 40. And the second metallic plane board 5 is close to but not connected to the first metallic plane board 40 to form an effect of serially connecting capacitances for the antenna structure. The antenna 4 is provided on a printed electric circuit board 7, the first metallic plane board 40 and the second metallic plane board 5 are provided respectively on two surfaces of the printed electric circuit board 7. Further, the antenna 4 has a first extension arm 41 extended therefrom for grounding, thereby the antenna structure forms an effect of parallelly connecting inductances. And the second metallic plane board 5 has a second extension arm 52 extended therefrom for grounding, thereby the antenna structure forms an effect of serially connecting inductances. The first metallic plane board 41 and the second extension arm 52 can both be made from microstrips.

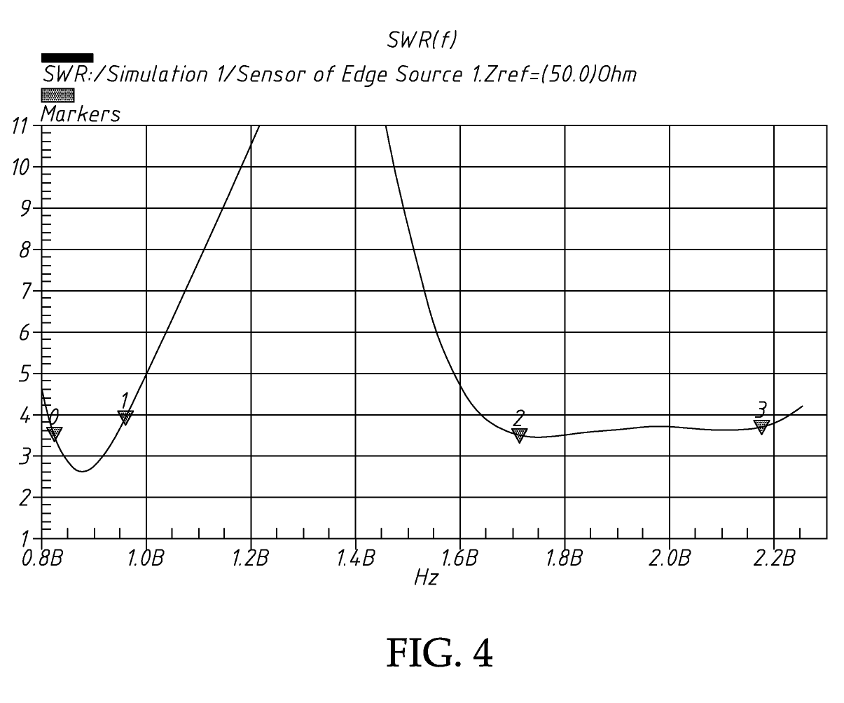

FIG. 4 shows a standing wave voltage ratio chart of the embodiment of FIG. 3, and shows that the antenna structure is a good multi-frequency antenna structure.

It is evident that the present invention has all the second metallic plane boards, the first and the second extension arms etc. made from microstrips, so that the matching method for the antenna structure is completed according to the principle of microstrip, such that frequency width and efficiency can be increased, this allows adjustment of the values of electric inductance and capacitance at will; not like a conventional antenna structure connected with SMT elements that can only select impedance of a standard value. Therefore, the present invention has significant superiority in designing antennas.

The preferred embodiments disclosed above are only for illustrating the present invention. It will be apparent to those skilled in this art that various modifications or changes made to the elements of the present invention without departing from the spirit of this invention shall also fall within the scope of the appended claims and are intended to form part of this invention.

1. An antenna structure having an effect of serially connecting capacitances comprising:
an antenna which is a metallic planar antenna used to receive and emit radio signals, and has thereon at least a first metallic plane board; and
a second metallic plane board close to but not connected to said first metallic plane board to form an effect of serially connecting capacitances for said antenna structure.

2. The antenna structure having an effect of serially connecting capacitances as defined in claim 1, wherein said antenna has an extension arm extended therefrom for grounding, thereby said antenna structure forms an effect of parallelly connecting inductances.

3. The antenna structure having an effect of serially connecting capacitances as defined in claim 2, wherein said antenna forms a second extension arm along a periphery of said first metallic plane board, said second extension arm is not grounded to make an effect of parallelly connecting capacitances.

4. The antenna structure having an effect of serially connecting capacitances as defined in claim 3, wherein said first metallic plane board and said second extension arm both are made from microstrips.

5. The antenna structure having an effect of serially connecting capacitances as defined in claim 1, wherein said antenna is provided on a printed electric circuit board, said first metallic plane board and said second metallic plane board are provided respectively on two surfaces of said printed electric circuit board.

6. The antenna structure having an effect of serially connecting capacitances as defined in claim 5, wherein said antenna has a first extension arm extended therefrom for grounding, thereby said antenna structure forms an effect of parallelly connecting inductances.

7. The antenna structure having an effect of serially connecting capacitances as defined in claim 6, wherein said second metallic plane board has a second extension arm extended therefrom for grounding, thereby said antenna structure forms an effect of serially connecting inductances.

8. The antenna structure having an effect of serially connecting capacitances as defined in claim 7, wherein said first metallic plane boardand said second extension arm are both made from microstrips.
